(19) United States
(12) Patent Application Publication
(10) Pub. No.: US 2001/0054021 A1
(43) Pub. Date: Dec. 20, 2001

(54) Electronic auction system, method and computer program product

(75) Inventors: Yasushi Kawakura, Kanagawa-ken (JP); Yasuhiko Suzuki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/819,893

(22) Filed: Mar. 29, 2001

(30) Foreign Application Priority Data
Mar. 31, 2000 (JP) 2000-096445

(51) Int. Cl. G06F 17/60

(52) U.S. Cl. 705/37; 705/26

(57) ABSTRACT

An electronic auction system, method and computer program product, including a server computer connected through a network to a plurality of terminals which participate in the auction, and including selecting merchandise information from a plurality of merchandise information on a basis of bid information bid by a participant; and causing to transmit the selected merchandise information as alternative merchandise to a terminal of the participant.

### CROSS-REFERENCE TO RELATED APPLICATIONS

This application claims benefit of priority under 35 USC § 119 to Japanese Patent Applications No. 2000-096445, filed Mar. 31, 2000, the entire contents of which is incorporated by reference herein.

### BACKGROUND OF THE INVENTION

1. Field of the Invention

The present invention relates to an electronic auction system, method and computer program product.

2. Discussion of the Background

According to the spread of the Internet in recent years, many Internet auction systems using the World Wide Web (WWW) have been developed. Generally, an Internet auction system includes an auction server of an auctioneer for providing a virtual auction space, one or more personal computers of exhibitors who register merchandise in the auction space, one or more personal computers of participants for accessing the auction space and for bidding on the registered merchandise and a network for connecting the auction server and the various personal computers. In such an auction system, the auction server generates WWW pages forming the virtual auction space. The WWW pages include a registration program for registering merchandise information, a display program for displaying the merchandise information and a bid program for allowing bidding on the merchandise corresponding to the merchandise information.

An exhibitor via a personal computer accesses the auction system's WWW page and registers, via the registration program, merchandise information, which is information about an offering of merchandise to be included in the auction system. A participant via a personal computer sees any available merchandise information, and if he wants to purchases available merchandise. In addition, the participant may bid on the merchandise via the bid program. When it is time for an auction of the merchandise to end, the auctioneer or the auction server determines the successful bidder of the merchandise based on a predetermined rule and the corresponding information supplied by each bid participant.

An Internet auction system similar to that described above is disclosed in U.S. Pat. No. 5,835,896. Generally, with such a system, an auction generates for participants feelings of expectation that one may be able to purchase a piece of merchandise cheaply, feelings of excitement as to whether a bid will be awarded, etc. However, in order for an auction to be successful, it is required that the number of registered merchandise and the number of participants in the auction is maintained at a suitable balance. If the number of participants per merchandise is small, then a proper bid price may not result. On the other hand, if the number of participants per merchandise is large, many participants who want the merchandise may be unable to make a successful bid. In such a case, if the auctioneer had had in the auction a lot of such high-demand merchandise, the auctioneer would have sold all such merchandise. However, neither of the above cases, except the latter, present a desirable situation for the auctioneer.

With the above-noted Internet auction systems one can attend the virtual auction space through the Internet via a personal computer without having to attend a brick and mortar auction hall. Accordingly, such Internet auction systems have the capability of attracting numerous participants as compared to their brick and mortar counterparts. However, such Internet auction systems typically gather participants in excessive rather than numbers appropriate for a given quantity of merchandise.

### SUMMARY OF THE INVENTION

Accordingly, the present invention is directed to an electronic auction system, method and computer program product that substantially obviates one or more of the above-noted problems with such conventional auction systems.

The above and other object are achieved according to the present invention by providing a novel electronic auction system, method and computer program product, including a server computer for electronically introducing merchandise information after closing an electrical auction, the server computer connected through a network to a plurality of terminals, which participate in the auction, the server computer including a merchandise database storing a plurality of merchandise information; selecting merchandise information from the merchandise database on a basis of provided bid information of a participant; and causing to notify the selected merchandise information as alternative merchandise information to a terminal.

In another aspect of the invention there is provided a server computer for electronically introducing merchandise information after closing an electrical auction, the server computer connected through a network to a plurality of terminals which participate in an auction, the server computer including an auction execution unit configured to hold an electronic auction, the auction execution unit comprising, a providing module configured to provide exhibited merchandise information for the auction to the terminals, and a receiving module configured to receive bid information, which includes bid information indicating a bidder from the terminals and configured to store the bid information; a merchandise database storing a plurality of merchandise information; selecting merchandise information from the merchandise database on a basis of the stored bid information of a bidder; and causing to notify the selected merchandise information as alternative merchandise information to a terminal.

In another aspect of the invention there is provided a server computer for electronically introducing merchandise information after closing an electrical auction, the server computer connected through a network to a plurality of terminals which participate in the auction, the server computer including extracting preference information on a basis of bid information stored for a bidder and exhibited merchandise information bid on by the bidder; causing a communication unit to transmit the preference information to an exhibitor.

In another aspect of the invention there is provided a server computer for electronically introducing merchandise information after closing an electrical auction, the server computer connected through a network to a plurality of terminals which participate in the auction, the server computer including a storage unit storing bid information; extracting preference information on the basis of bid information stored for a bidder and exhibited merchandise information bid on by the bidder; associating the preference information and bid information and for storing same; receiving alternative merchandise information selected by an exhibitor; causing to notify the alternative merchandise information as alternative merchandise to a terminal on a basis of the associated preference information and bid information.

In another aspect of the invention there is provided a server computer for electronically introducing merchandise information after closing an electrical auction, the server computer connected through a network to a plurality of terminals which participate in the auction, the server computer including extracting preference information on a basis of bid information stored for a bidder and exhibited merchandise information bid on by the bidder; causing a communication unit to transmit the preference information to an exhibitor; receiving alternative merchandise information selected by the exhibitor; causing to notify the alternative merchandise information as alternative merchandise to a terminal.

In another aspect of the invention there is provided a server computer for electronically introducing merchandise information after closing an electrical auction, the server computer connected through a network to a plurality of terminals which participate in the auction, the server computer including holding the auction electronically, the auction holding means, comprising, providing exhibited merchandise information for the auction to the terminals, and receiving bid information, which includes information indicating a bidder, from the terminals and for storing the bid information; extracting preference information on a basis of bid information stored for a bidder and exhibited merchandise information bid on by the bidder; causing a communication unit to transmit the preference information to an exhibitor; receiving alternative merchandise information selected by the exhibitor; causing to notify the alternative merchandise information as alternative merchandise to the terminal.

In another aspect of the invention there is provided a method of electronically introducing merchandise information to a participant bidding in an electronic auction after closing the electronic auction, in a system including a server computer connected through a network to a plurality of terminals which participate in the auction, the method including selecting merchandise information from a plurality of merchandise information on a basis of bid information bid by a participant; and causing to transmit the selected merchandise information as alternative merchandise to a terminal of the participant.

In another aspect of the invention there is provided a method of electronically introducing merchandise information after closing an electronic auction, including providing exhibited merchandise information for the auction to terminals of participants, receiving bid information, which includes information indicating each participant from the terminals; storing the bid information; selecting merchandise information from a plurality of merchandise information on a basis of the stored bid information; and causing to transmit the selected merchandise information as alternative merchandise to a terminal of a participant.

In another aspect of the invention there is provided a method of electronically introducing merchandise information to a participant bidding in an electronic auction after closing the auction, including extracting preference information on a basis of bid information and exhibited merchandise information bid on by a participant; causing to transmit the preference information to a terminal of an exhibitor.

In another aspect of the invention there is provided a method of electronically introducing merchandise information after closing an electrical auction, including storing bid information; extracting preference information on a basis of bid information stored for a bidder and exhibited merchandise information bid on by the bidder; associating the preference information and bid information and storing same; receiving alternative merchandise information selected by an exhibitor; and causing to notify the alternative merchandise information as alternative merchandise to a terminal on a basis of the associated preference information and bid information.

In another aspect of the invention there is provided an auction system, including a plurality of terminals offering bids for exhibited merchandise information in an electronic auction; and a server computer connected the plurality of terminals through a network, configured to hold the auction, the server, including, a providing module providing exhibited merchandise information to the terminals, a receiving module receiving bid information, which includes information indicating a bidder from the terminals and storing the bid information; a merchandise database storing a plurality of merchandise information; selecting merchandise information from the merchandise database on a basis of stored bid information for a bidder; and causing to notify the selected merchandise information as alternative merchandise to a terminal of the bidder.

In another aspect of the invention there is provided an auction system, including a plurality of terminals offering a bid on exhibited merchandise information; a terminal of an exhibitor; and a server computer, connected the plurality of terminals and the terminal of the exhibitor through a network, and configured to hold an auction, the server, including, providing exhibited merchandise information for the auction to the terminals, and receiving bid information, which includes information indicating a bidder from the terminals and for storing the bid information, extracting preference information on a basis of the stored bid information of the bidder, and the exhibited merchandise information bid on by the bidder; causing a communication unit to transmit a preference information to the exhibitor; receiving an alternative merchandise information selected by exhibitor; causing to notify the alternative merchandise information as an alternative merchandise to the terminal.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary top-level system diagram for illustrating an auction system, according to the present invention;

FIG. 2 is a flow chart for illustrating processing performed by an auction execution process of a server and a terminal in the system of FIG. 1, according to the present invention;

FIG. 3 is a flow chart for illustrating processing performed by a bid notification process of a server and a terminal in the system of FIG. 1, according to the present invention;

FIG. 4 is a flow chart for illustrating processing performed by a purchase application process of a server and a terminal in the system of FIG. 1, according to the present invention;

FIG. 5 is an exemplary diagram for illustrating an auction process as performed in the system of FIG. 1, according to the present invention;

FIG. 6 is an exemplary diagram for illustrating a merchandise database, according to the present invention;

FIG. 7 is an exemplary diagram for illustrating auction notifications, according to the present invention;

FIG. 8 is an exemplary diagram for illustrating a homepage of the system of FIG. 1, according to the present invention;

FIG. 9 is an exemplary top-level system diagram for illustrating an auction system, according to another embodiment of the present invention;

FIG. 10 is a flow chart for illustrating processing performed by the system of FIG. 9, according to the present invention;

FIG. 11 is an exemplary diagram for illustrating an auction process as performed in the system of FIG. 9, according to the present invention; and

FIG. 12 is an exemplary computer system, which may be programmed to perform one or more of the processes of the present invention.

### DETAILED DESCRIPTION OF THE PREFERRED EMBODIMENTS

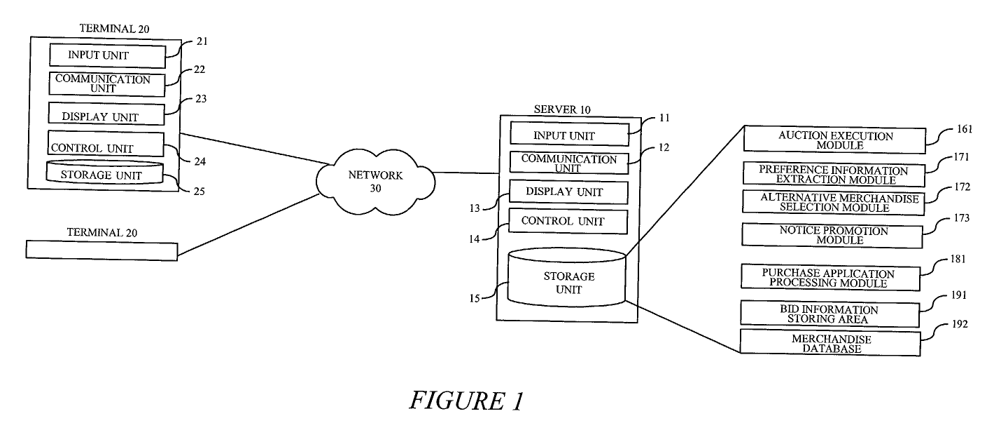

Referring now to the accompanying drawings, wherein like reference numerals designate identical or corresponding parts throughout the several views or diagrams, and more particularly to FIGS. 1 through 12 thereof, there are illustrated various embodiments of the electronic auction system, method, and computer program product of the present invention.

FIG. 1 is an exemplary top-level system diagram for illustrating an auction system, according to the present invention. In FIG. 1, the auction system includes an auction server 10 (e.g., used by an auctioneer), one or more terminals 20 (e.g., personal computers, cellular phones, digital TVs, personal digital assistants (PDAs), etc.) of the auction system participants and a network 30 (e.g., a communications network, the Internet, an Intranet, a combination thereof, etc), which connects the server 10 to terminals 20.

The auction server 10, such as a Web server, programmed general purpose computer or work station, etc., includes a input unit 11, such as a keyboard, a mouse, a scanner, etc., for inputting data, programs, and contents. A communication unit 12 is provided for communicating to the devices 20 via the network 30 and for transmitting merchandise information exhibited in an auction, alternative merchandise information, etc., to the terminals 20. A display unit 13 is provided for displaying information to prompt for input, for displaying status of Internet auction, etc. A control unit 14 is provided for performing data processing functions for controlling the server 10, for controlling communications with the devices 20, etc. A storage unit 15 is provided for storing and retrieving information, such as auction parameters and information, computer programs, auction Web site homepage, etc.

The storage unit 15 stores, for example, program modules 161-181, bid information 191, merchandise database 192, etc. An auction execution program 161 is provided for executing a series of functions for conducting an Internet auction, for storing bid information by participants, etc. A preference information extraction program 171 extracts preference information of a participant's bid during an auction, etc. An alternative merchandise selection program 172 is provided for selecting alternative merchandise based on extracted preference information of each participant, etc. A notice promoting program 173 is provided for causing the communication unit 12 to notify information regarding alternative merchandise to a participant, etc. A purchase application processing program 181 is provided for processing a purchase application applied according to a notice of a successful bid or alternative merchandise, etc. The programs 161, 171, 172, 173 and 181 are executed via the control unit 14. A bid information storing area 191 stores bid information received by the auction execution program 161 corresponding to exhibited merchandise information. A merchandise database 192 stores merchandise information from various exhibitors. The program modules 161-181, the bid information 191, the merchandise database 192, etc., will be further described below.

In FIG. 1, each participant's terminal 20 includes, for example, an input unit 21 for inputting bid information, for inputting a purchase application according to a notice of a successful bid or alternative merchandise received from the server 10, etc. A communication unit 22 is provided for communicating to access to the server 10, for transmitting bid information, for transmitting purchase application information, etc., to the server 10. A display unit 23 is provided for displaying exhibited merchandise information in auction, for displaying a bid competition status, for displaying alternative merchandise information, etc. A control unit 24, such as a microprocessor, etc., is provided for controlling the terminal 20, etc. A storage unit 25 is provided for storing an operating system (OS), programs, data, etc.

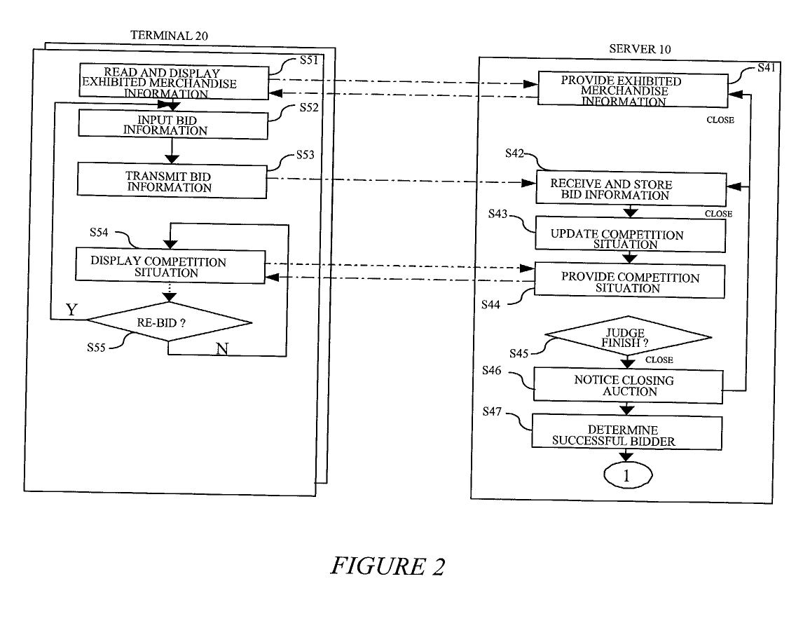

Referring now to the flow charts of FIGS. 2-4, the operation of the auction system of FIG. 1 will now be described in detail. FIG. 2 is a flow chart for illustrating processing performed by the auction execution program 161 of the server 10 and one or more of the terminals 20 in the system of FIG. 1. In FIG. 2, the auction execution program 161 exhibits merchandise information provided by an exhibitor to a participant (step S41). Bid information from a participant is received and notification of a bid competition status in the auction is performed (steps S42-S44). The end of the auction is determined and a successful bidder is determined (steps S45-S47). The above-noted processes may be operated in parallel.

In FIG. 2, an auctioneer arranges exhibited merchandise information on a virtual auction space via the server 10 and opens a homepage of the Internet auction (step S41). By specifying the homepages address of the server 10, a terminal 20 of a participant accesses the server 10 through the network 30, and loads the homepages of the auction from the server 10 (step S51), which then is displayed on the display unit 23. If the participant find merchandise to bid on from that exhibited on the homepages, the participant inputs the necessary information, such as the desired merchandise, a bid amount, an e-mail address, home address, etc., to bid on the merchandise (step S52) and submits a bid via the input unit 21. In this way, the bid information is transmitted to the auction server 10 through the network 30 (step S53). As a bidding method, various methods are applicable, such inputting a bid price directly, responding to a bid price from the auctioneer, etc.

The server 10 stores the received bid information in the bid information storing area of the storage unit 15 (step S42). Then, a current bid competition status is updated by using the stored bid information (step S43). The updated bid competition status is arranged on the homepage of the auction via the server 10 (step S44). In this way, the auction participants can receive and display the bid competition status by accessing the server 10 (step S54). The bid competition status is displayed on the display unit 23 of the terminal 20 of a participant and the participant may then submit a new bid (step S55). In this case, processing returns back to step S52.

As explained above, although the server 10 provides exhibited merchandise information and bid competition status separately, the server 10 may provide the exhibited merchandise information and the bid competition status information at a same time. In such as case, a new bid can be submitted while a bid competition status is displayed. In addition, the bid competition status of the auction may be open to all participants or be maintained in secret.

The server 10 determines whether or not an auction has satisfied conditions for completion (step S45). When an auction is determined to have been completed, the server 10 closes the auction and provides the exhibited merchandise information (step S46). Such conditions for determination of completion of the auction may be conditions, such a predetermined time limit, not receiving a new bid during a predetermined time period, etc.

The server 10 determines a successful bidder according to bid information, after closing the auction (step S47). As a method of determining a successful bidder, various methods may be employed, such as the highest bidder, the nearest bid to an exhibitor's asking price, etc. The exhibitor's asking price may be kept secret or may be made available to the participants.

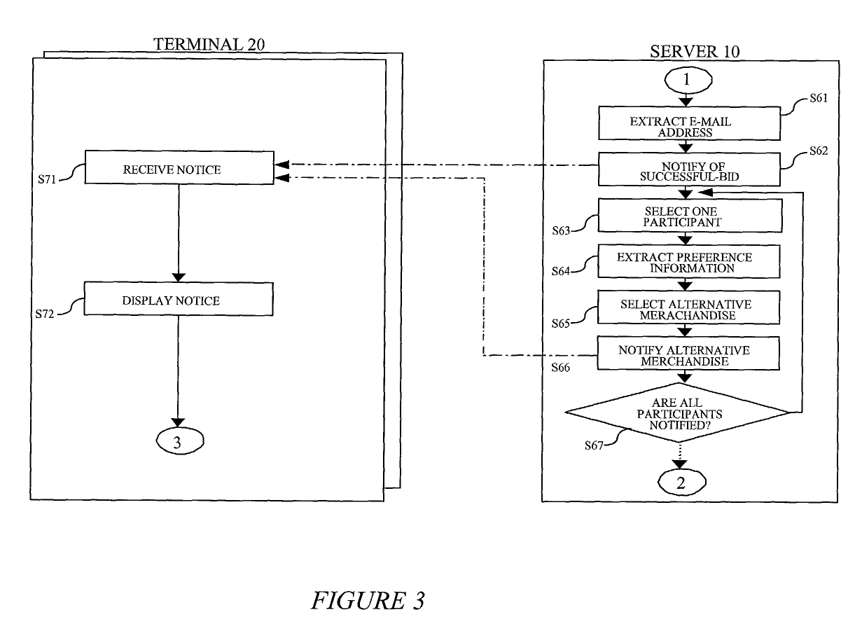

FIG. 3 is a flow chart for illustrating processing performed by a bid notification process of the server 10 and the terminal 10 in the system of FIG. 1. In FIG. 3, a notice regarding a successful bid may be sent to a successful bidder, a notice of alternative merchandise may be sent to each unsuccessful bidder, etc., after the closing of the auction. The notice promotion program 173 in the server 10 obtains an address (e.g., e-mail address, post office address, etc.) of a successful bidder from the bid information stored in the storage unit 15 (step S61). The server 10 then notifies the successful bid to the successful bidder based on the obtained address (step S62).

The preference information extraction program 171 in the server 10 selects one or more of the participants without a successful bid from all the bid information stored in the storage unit 15 (step S63) and extracts preference information based on the exhibited merchandise information, which was bid on by the participants and the bid information of the participants (step S64). Elements of the preference information are, for example: (i) the kind of merchandise (e.g., personal computer, car, watch, etc.); (ii) the type of merchandise (e.g., notebook or desktop PC, sedan, RV, minivan, car, etc.); (iii) the specifications of the merchandise (e.g., processing speed of CPU in PC, memory capacity of PC, color of car, displacement of car, etc.); (iv) price range (e.g., ten percent of the upper and lower ends of a bid price, etc.; and/or (v) dirtiness or problems with the merchandise (e.g., key “B” of keyboard is dirty, automatic mirror is broken, etc.).

The preference information is information including the above-noted elements, which are extracted from the bid information and the merchandise information. For example, sample preference information may be “car”, “sedan”, “2,000 CC” and “$10,000”.

The alternative merchandise selection program 172 of the server 10 uses the extracted preference information as a key and then searches the merchandise database 192, which stores information regarding merchandise in stock, based thereon for alternative merchandise, which is selected and will be provided to the unsuccessful bidder participants (step S65).

After selecting the alternative merchandise, the notice promoting program 173 of the server 10 obtains the address of the participant from the stored bid information. The notice promoting program 173 then causes the communication unit 12 to notify the unsuccessful bidders with regard to the alternative merchandise. The communication unit 12 of the server 10 then transmits, for example, e-mail messages regarding the alternative merchandise to the unsuccessful bidder participants through the network 30 (step S66).

The program 173 checks whether or not the notice of a successful bid or the notice of alternative merchandise has been sent to all the participants (step S67). When not all the participants have been notified, the server 10 repeats the processes of steps S63 to S66 so as to notify all the remaining participants.

Via terminal 20, each participant receives the notice of the successful bid, or the notice of alternative merchandise (step S71). The notice is then displayed on the display unit 23 of the respective participants (step S72).

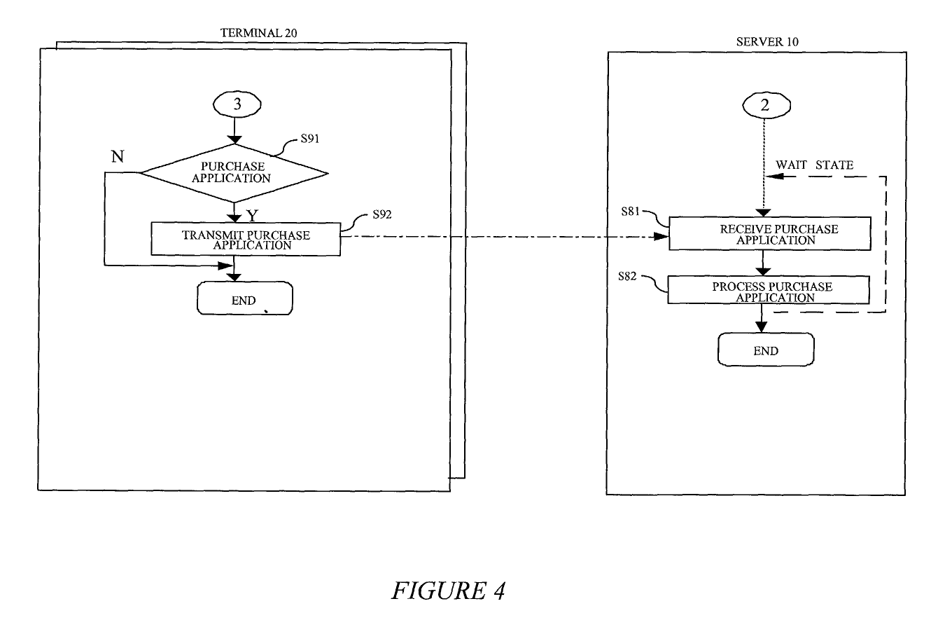

FIG. 4 is a flow chart for illustrating processing performed by a purchase application process of the server 10 and the terminal 20 in the system of FIG. 1. In FIG. 4, a participant checks the notice displayed on the terminal 20. If the participant wishes to apply to purchase the merchandise included in the notice, the participant, for example, clicks on an “application button” appended to the notice, or else takes no action. The terminal 20 detects if the button is clicked (step S91) and then transmits information regarding a purchase application to the server 10 (step S92).

After server 10 has notified all the participants of the alternative merchandise, the server 10 is held in a wait state waiting to receive the purchase application. When the server 10 receives the purchase application from the terminal 20, the purchase application processing program 181 of the server 10 processes the purchase application (step S82). For example, such processing may include arrangements for the participant to purchase the alternative merchandise.

Accordingly, by using bid information, the server 10 of the present invention is able to introduce information regarding preferable and alternative merchandise to participants. That is, each participant is notified regarding alternative merchandise, which they may want to buy and the exhibitors of such alternative merchandise may end up with potential sales thereof. In addition, in order to improve the selecting process of the alternative merchandise, when the server 10 receives a purchase application regarding the alternative merchandise, the server 10 may feed back the information to the extracting process of preference information of step S64, and the selecting process of alternative merchandise of step S65 to further refine the alternative merchandise selection and notification processes.

In the above embodiment, the notice (steps S62, S66) to the successful bidder or the unsuccessful bidder is performed via e-mail. However, the server 10 may print via a notice document to be sent via, for example, regular mail, facsimile, etc. That is, the method of transmitting the notice may be based on any method via the server 10 that generates a notice to a participant. The address, which is a part of bid information, may thus include a home address, a telephone number, etc., corresponding to the particular notice method employed.

Although the notice of alternative merchandise may be sent to all participants or unsuccessful bid participants, such notice may be sent to only participants wishing to receive such a notification. To implement this feature, step S63 for selecting a participant may exclude participants not wishing to be notified of alternative merchandise.

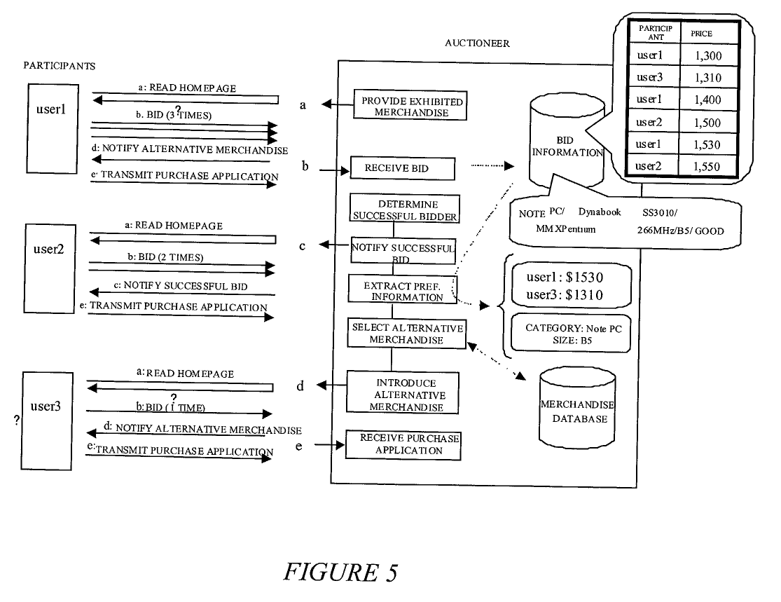

The above-noted embodiment will now be further explained with exemplary FIGS. 5-8. In FIGS. 5-8, the example is defined, as follows: (i) the exhibited merchandise in the auction is a notebook type personal computer, a “Dynabook SS3010”; (ii) three participants of the auction are user1, user2 and user3; (iii) the auction is held via an Internet Web page; and (iv) a successful bidder is a participant with the highest final bid price.

An auctioneer next arranges the “Dynabook SS3010” on an auction homepage in the server 10 and opens the auction. Each participant accesses the server 10 through the network 30 via respective terminals 20. The auction homepage is displayed on the browser of each terminal 20 of each participant (elements a of FIG. 5). Each participant finds “Dynabook SS3010” from an exhibition merchandise list of the auction homepage. The homepage then directs display of the merchandise information on each participant's browser.

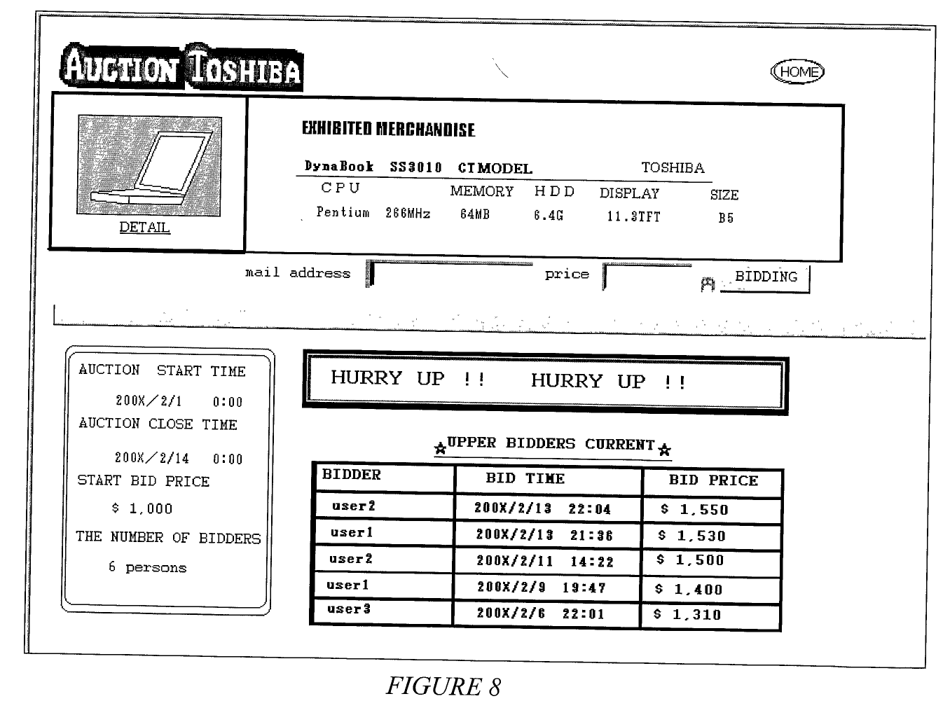

Then, each participant checks the merchandise information regarding the “Dynabook SS3010” and determines that bids have been offered (FIG. 8). Each participant then inputs their address (e.g., e-mail address, etc.) and a price they wish to bid, which is the bid information. Then, a bid button is pushed (elements b of FIG. 5).

The auction page is collectively displayed reflecting the five highest bids (FIG. 8). Each participant then can re-bid based on such displayed information. In this example, a first, user1, offers a bid price of $1,300 and the offered bids are in the order of user1, user3, user1, user2, user1 and user2 (FIG. 5). Whenever the server 10 receives the respective bid information, the bid information is associated with the corresponding merchandise information and is stored. If the auction reaches the end time, the server 10 closes the auction and determines a successful bidder. In this example, user2 at the final bid price of $1,550 is the successful bidder.

The server 10 then obtains the address of the user2 from the stored bid information and notifies the successful bidder of the successful bid using such address(element c of FIG. 5). The server 10 then respectively extracts preference information for each participant, excluding the successful bidder, as follows. Participants excluding the successful bidder are user1 and user3, the server 10 thus extracts the highest bid price of user1 and user3 from the stored bid information. The user1 is bid is thus extracted as $1,530, whereas the user3 bid is extracted as $1,310. In addition, the server 10 extracts the merchandise information of the user1 and the user3 as “Dynabook SS3010, category: notebook PC, size: B5”.

The server 10 then generates the user1's preference information and the user3's preference information from the extracted highest bid price and the extracted merchandise information. That is, the user's preference information is “type: notebook PC, size: B5, price:$1,530” and the user3's preference information is “type: notebook PC, size: B5, price:$1,310” in this example. The server 10 then selects a predetermined number of alternative merchandise from a merchandise database according to a predetermined rule based on each participant's extracted preference information. In this example, the predetermined rule may be “type and size must be the same and price must be close (e.g., within x%)” and “a predetermined number of alternative merchandise is two”.

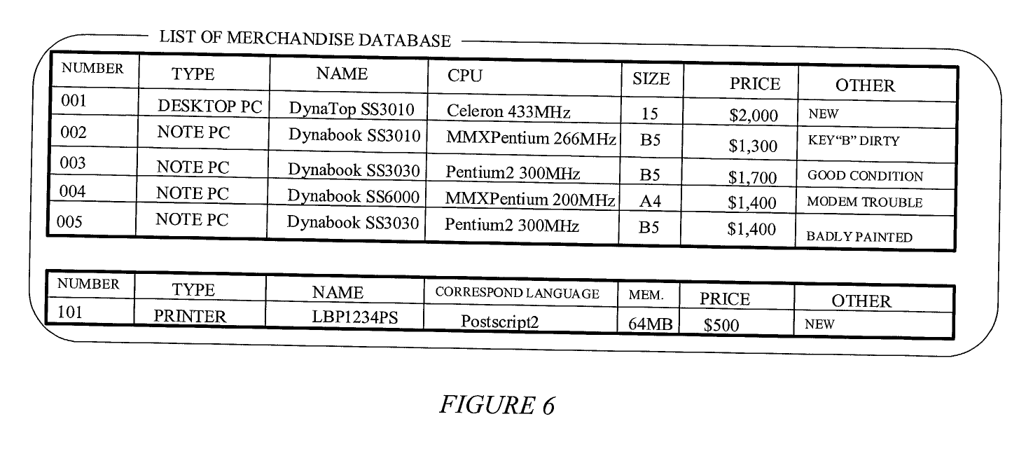

Accordingly, merchandise with inventory numbers 003 and 005 (FIG. 6) are selected from a list in the merchandise database as alternative merchandise for user1. Similarly, merchandise with inventory numbers 002 and 005 (FIG. 6) are selected as alternative merchandise for user3. Once the user1 and user3's alternative merchandise is selected, the server 10 sends notification information regarding the alternative merchandise to user1 and user3 respectively (elements d of FIG. 5).

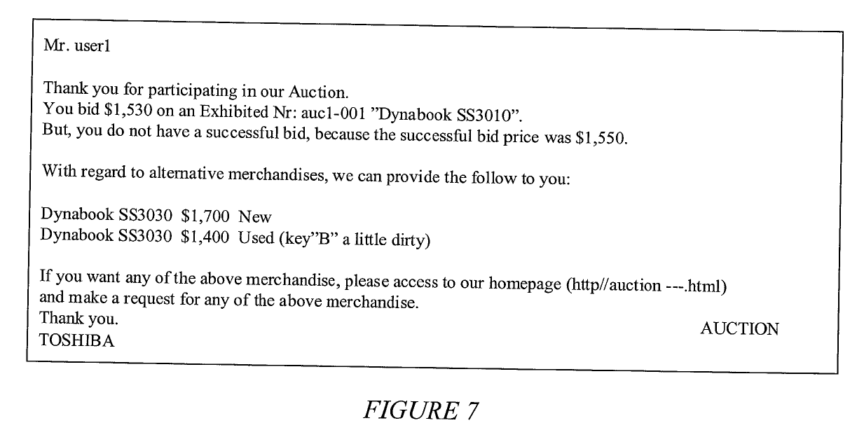

The notice method in this example is as follows: (i) the server 10 has an introduction message regarding alternative merchandise pre-stored in a given format beforehand; (ii) the server 10 then generates an appropriate introduction message automatically based on the pre-stored format and the information regarding the selected alternative merchandise (FIG. 7); (iii) the server 10 then obtains the respective e-mail addresses of the user1 and the user3 from the bid information; and (iv) the server then transmits the respective appropriate generated introduction message automatically using the respective e-mail addresses.

The user2 then receives the notice regarding the successful bid displayed on the terminal 20 of the user 2. Similarly, the user1 and the user 3 receive their respective introduction messages displayed on their terminals 20. The user2 and user3 may then requests a purchase application, when they wish to purchase any of the alternative merchandise (elements e of FIG. 5).

The Internet auction of the above embodiment, advantageously, can introduce preferable alternative merchandise information instead of merely providing unsuccessful bid information. In this way, the participants are provided information regarding alternative merchandise which they may wish to purchase and other exhibitors can thus be introduced to participants that may wish to buy such alternative merchandise. In above system, an auctioneer and an exhibitor may be the same person.

In the above embodiment, the server 10 of the auctioneer selects the alternative merchandise information based on the participant preference information and notifies of selected alternative merchandise information to terminals 20 of non-successful bid participants. In another embodiment, the server 10 of the auctioneer provides participants' preference information to an exhibitor, the exhibitor selects alternative merchandise based on the participants' preference information and provides information regarding selected alternative merchandise to the auctioneer and the server 10 of the auctioneer notifies of the provided alternative merchandise information to non-successful bid participants.

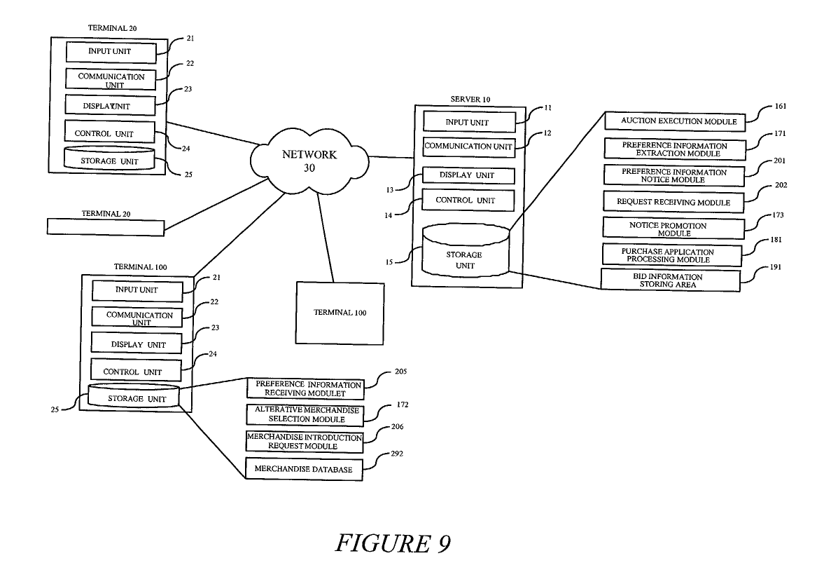

FIG. 9 is an exemplary top-level system diagram for illustrating an auction system according to the above-noted other embodiment of the present invention. In the FIG. 9, like reference numerals designate identical or corresponding parts in FIG. 1 and an explanation of such identical or corresponding parts is omitted for the sake of brevity.

FIG. 9, the auction system includes an auction server 110 used by an auctioneer, one or more terminals 20 of participants, one or more terminals 100 of exhibitors who exhibit merchandise on the auction, and a network 30, which connects the server 10 to the terminals 20 and to the terminals 100. The auction server 110 includes an input unit 11, a communication unit 12, a display unit 13, a control unit 14, a storage unit 15, etc., and which function is similar manner as described with respect to the corresponding components of FIG. 1.

The storage unit 15 stores an auction execution program 161, a preference information extraction program 171, a notice promotion program 173 and a purchase application processing program 181 and has a bid information storing area 191, as in FIG. 1. In this embodiment, however, the storage 15 further includes a preference information notice program 201 for classifying preference information per exhibited merchandise information and for notifying of the classified preference information to the terminal 100 of the exhibitor and a request receiving program 202 for receiving a request for introducing alternative merchandise information, as compared to the embodiment of FIG. 1. In addition, in this embodiment, the storage unit 15 does not include the alternative merchandise selection program 172 and the merchandise database 192, as in the embodiment of FIG. 1.

Each terminal 100 of exhibitors includes an input unit 21, a communication unit 22, a display unit 23, a control unit 24 and a storage unit 25. The storage unit 25 stores an alternative merchandise selection program 172 and a merchandise database 192, similar to the alternative merchandise selection program 172 and the merchandise database 192 of the server 10 of the embodiment of FIG. 1. The storage unit 25 stores a preference information receiving program 205 for receiving preference information, which is notified from the server 110 through the network 30 and merchandise introduction request program 206 which requests introduction of the selected alternative merchandise information by an exhibitor to participant via the server 110.

The following describes the operation of the auction system of FIG. 9. In the auction system of FIG. 9, the processing regarding performing an auction (FIG. 2) and the processing regarding performing a purchase application (FIG. 4) may be the same as that of the system of FIG. 1 and is omitted here for the sake of brevity. On the other hand, operations regarding providing a notice of a successful bid to a successful bidder and providing notices regarding alternative merchandise to unsuccessful bidders, after closing the auction differ from that of the embodiment of FIG. 1 and will be described in detail.

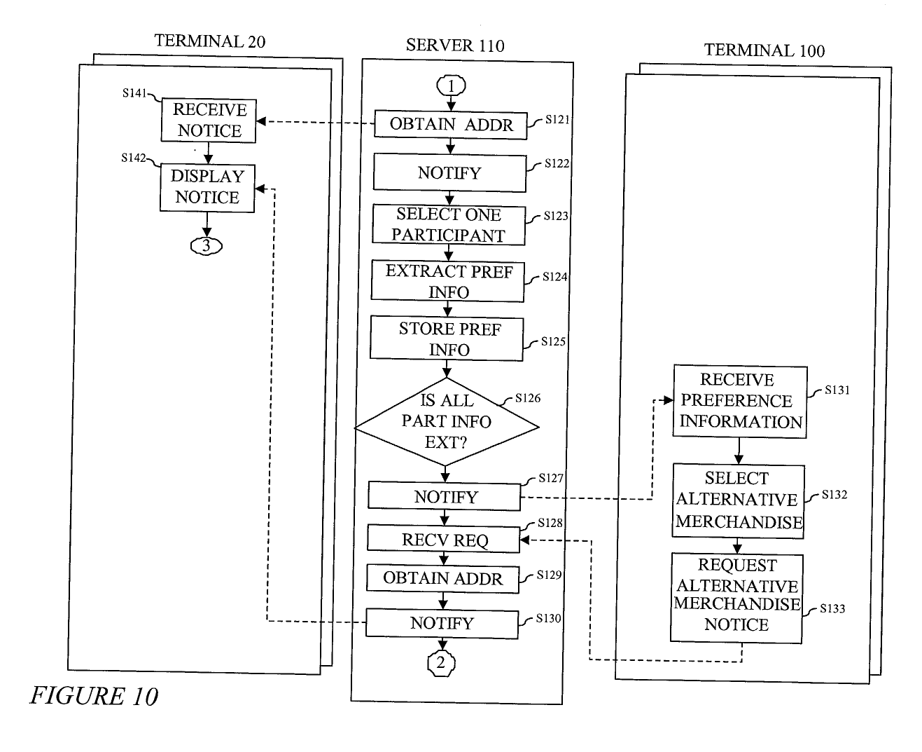

FIG. 10 is a flow chart for illustrating processing performed by the system of FIG. 9, according to the present invention. In FIG. 10, the notice promotion program 173 of the server 110 obtains the address (e.g., e-mail address, etc.) of a successful bidder from the bid information stored in the storage unit 15 (step S121). The program 173 of the server 110 notifies of the successful bid to the successful bidder based on the obtained address (step S122). The preference information extracting program 171 selects participants except for the successful bidder (step S123). The program 171 extracts preference information (step S124). The extracted preference information is associated with the corresponding participant information (e.g., participant ID, participant address, etc.). The program 171 stores such information in the storage unit 15 (step S125). The program 171 repeats steps S123-S125, and obtains all participants' preference information (step S126).

The preference information notice program 201 classifies the preference information of the participant based on the exhibited merchandise of the auction, after obtaining preference information for all of the participants. The program 201 then notifies respective preference information on the terminals 100 of the corresponding exhibitors (step S 127). That is, an exhibitor A is notified of preference information of participants who offered a bid on merchandise A exhibited by the exhibitor A. Similarly, an exhibitor B is notified of preference information of participants who offered a bid on merchandise B exhibited by the exhibitor B. This process continues until all exhibitors are notified.

The above notice may be sent through the network 30 in electronic form or may be sent via facsimile, letter, phone, etc. The preference information receiving program 205 in the terminal 100 of an exhibitor receives the preference information regarding their exhibited merchandise (step S131). The alternative merchandise selecting program 172 of the terminal 100 uses this received preference information as a key, and selects alternative merchandise corresponding to the preference information from the merchandise database 192 in the storage unit 25 of the terminal 100 and the merchandise introduction request program 206 associates the selected alternative merchandise with the preference information (step S132).

The program 206 then requests introduction of the selected alternative merchandise to the corresponding participants and based on such request, the communication unit 22 of the terminal 100 transfers an introduction message regarding the alternative merchandise, wherein the alternative merchandise introduction message may be created beforehand, and transfers the preference information and the alternative merchandise information (step S133). Such information may be transferred using any suitable transmission method, such electrically through the network 30, via facsimile, via letter, etc.

When the request for alternative merchandise introduction is received by the request receiving program 202 of the server 110 (step S128), the notice promotion program 173 of the server 110 searches the bid information based on the preference information received from the exhibitor and the program 173 extracts participants' addresses included in the searched bid information (step S129). In addition, if in step S125, the information of the participant is the participant's e-mail address, step S 129 can be expedited.

The program 173 of the server 110 then causes the communication unit 12 to notify each participant with the alternative merchandise introduction message introducing the received alternative merchandise via the extracted address (step S130). Each participant is notified, for example, via e-mail through the network 30 via the communication unit 12 of the server 110. The terminal 20 of the respective participant receives the notice of a successful bid, or the notice of alternative merchandise (step S141) and the notice is displayed on the display unit 23 of the respective participant (step S143). In addition, respective participants may apply for a purchase application either directly from a corresponding exhibitor or via an auctioneer, in a similar manner as described with respect to FIG. 4. In addition, although not shown, the server 110 may edit into intelligible form the preference information (e.g., perform language translation), an notify the exhibitors of the preference information in such corresponding intelligible form.

According to the above embodiment, the server 110 provides preference information, which may be beneficial to respective exhibitors. In addition, by receiving the request from an exhibitor (step S133), the server 110 is able to introduce information of regarding preferable and alternative merchandise to respective participants. In this way, the participants are provided information regarding alternative merchandise which they may wish to purchase and other exhibitors can thus be introduced to participants that may wish to buy such alternative merchandise.

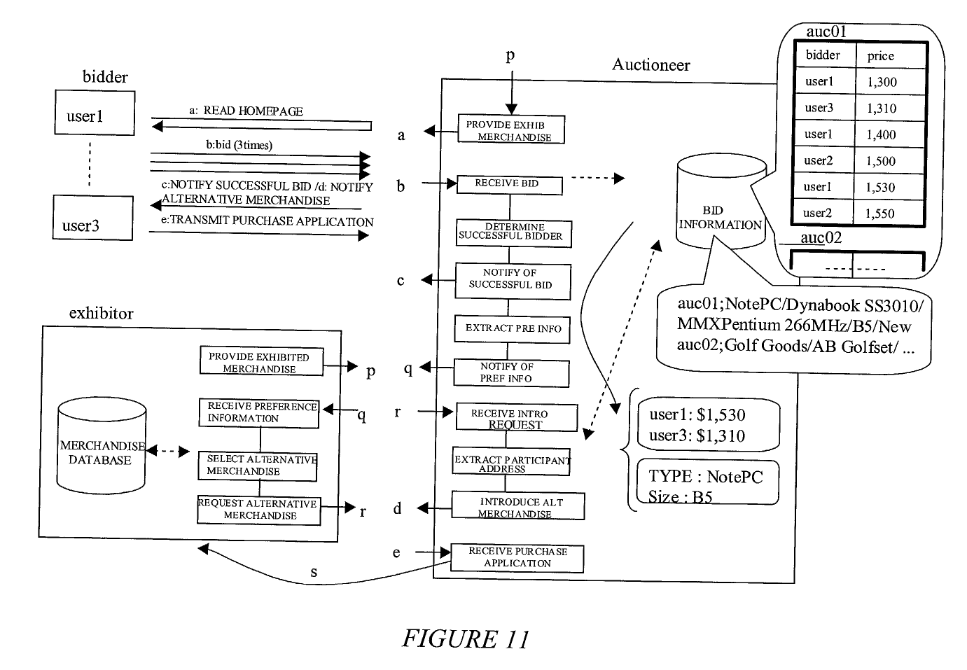

FIG. 11 is an exemplary diagram for illustrating an auction process as performed in the system of FIG. 9, according to the present invention. In FIG. 11, only operations that are different than that of the embodiment of FIG. 1 will be described for the sake of brevity. In FIG. 11, an exhibitor exhibits merchandise on an auction. For example, the exhibitor exhibits a “Dynabook SS3010” and inputs the corresponding merchandise information regarding the “Dynabook SS3010” via the input unit 21 of the terminal 100 of the exhibitor. The exhibitor then transmits the merchandise information regarding the “Dynabook SS3010” to the server 110 which holds an auction via the network 30. The serve 110 is registred to display a homepage for the auction, in order to display the Dynabook S3010 information as exhibition information for the auction, after receiving the merchandise information from the exhibitor. The server 110 is thus able to present to participants of the auction the exhibited merchandise information when the auction is open.

In this embodiment, the operations regarding registration of exhibited merchandise information to extraction of the preference information of unsuccessful bidders are the same as that of the embodiment of FIG. 1 and are omitted here for the sake of brevity. The server 110, after extracting preference information, classifies the preference information per the exhibited merchandise information. The server 110 then notifies each exhibitor who sent exhibited merchandise information of the classified preference information (element q of FIG. 11). For example, in the Internet auction, an exhibitor A exhibits “Dynabook SS3010” and an exhibitor B exhibits “AB golf set.”. The server 110 then classifies the preference information of the person who bid for the “Dynabook SS3010” and the preference information of the person who bid for the “AB golf set.” The exhibitor A is then notified of the preference information of the person who bid for the “Dynabook SS3010” and the exhibitor B is notified of the preference information of the person who bid for the “AB golf set.”

The terminal 100 of the exhibitor who received the notice of preference information then searches the merchandise database 192 based on the preference information, which was received via the notice and selects alternative merchandise. In order for an exhibitor to perform a merchandise information introduction request, the exhibitor groups information for performing a merchandise information introduction request, the information which shows the alternative selected merchandise, and the preference information, and then transmits same to the auctioneer's server 110. Thereby, the merchandise information introduction request is performed (element r of FIG. 11).

When the request is received, the server 110 searches the bid information using the preference information as a key, specifies the participants corresponding to respective preference information, and extracts the participants'e-mail address. By repeating this e-mail address extraction process, the merchandise information received from the exhibitor is shown to suitable participants. Further operations progress in similar as described with respect to the embodiment of FIG. 1. In addition, the server 110 notifies the exhibitor if a purchase application is received from a participant (element s of FIG. 11).

With the Internet auction method of the present embodiment, the participants are provided information regarding alternative merchandise which they may wish to purchase and other exhibitors can thus be introduced to participants that may wish to buy such alternative merchandise.

In the present embodiment, since a function is provided that supplies a participant's preference information to an exhibitor from an auctioneer, the exhibitor of an auction can obtain the preference information. The preference information is very important for exhibitors since it reflects market demands. Therefore, more exhibitors are likely to participate in the auction due to the added value of the supplying of the participants' preference information.

In addition, since the auctioneer has a participant's bid information, when an introduction request of merchandise information is received from an exhibitor, the auctioneer can introduce the merchandise information to suitable participants. That is, the exhibitor who wants to introduce merchandise information is satisfied because the merchandise information is introduced to people which may wish to buy the merchandise. The auctioneer in turn can expect many participants due to such features. The participant in turn has his own information keep secret without it being provided to an exhibitor while being able to obtain alternative merchandise information. The systems of the embodiments of FIGS. 1 and 9 provide new and improved systems for performing electronic commerce.

The previously described processes include appropriate data structures for storing data collected and/or generated by the processes of the systems of FIG. 1 or 9 in one or more databases thereof. Such data structures accordingly will includes fields for storing such collected and/or generated data.

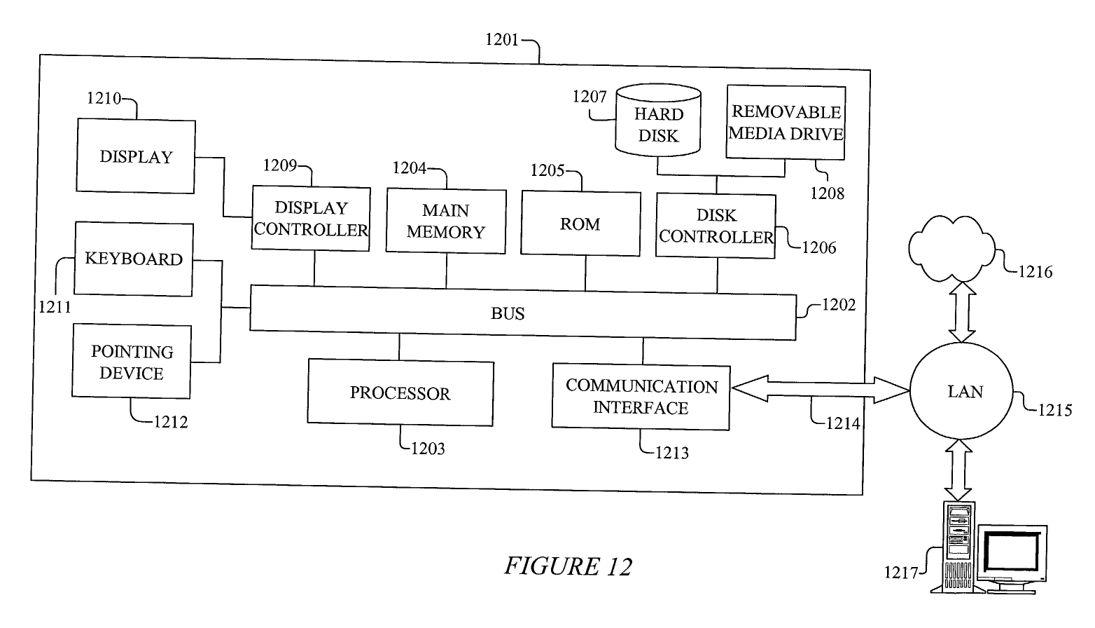

All or a portion of the invention (e.g., as described with respect to FIGS. 1-11) may be conveniently implemented using conventional general purpose computers or microprocessors programmed according to the teachings of the present invention (e.g., using the computer system of FIG. 12), as will be apparent to those skilled in the computer art. Appropriate software can be readily prepared by programmers of ordinary skill based on the teachings of the present disclosure, as will be apparent to those skilled in the software art. In addition, the present invention may be implemented on the World Wide Web (e.g., using the computer system of FIG. 12).

FIG. 12 illustrates a computer system 1201 upon which the present invention (e.g., servers 10/110, terminals 20/100, etc.) may be implemented. The present invention may be implemented on a single such computer system, or a collection of multiple such computer systems. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of the data structures/information of the system shown in FIGS. 1-11, or any other data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1221 typically provides data communication through one or more networks to other data devices. For example, network link 1221 may provide a connection to a computer 1225 through local network 1223 (e.g., a LAN) or through equipment operated by a service provider, which provides communication services through a communications network 1227. In preferred embodiments, local network 1223 and communications network 1227 preferably use electrical, electromagnetic, or optical signals that carry digital data streams. The signals through the various networks and the signals on network link 1221 and through communication interface 1219, which carry the digital data to and from computer system 1201, are exemplary forms of carrier waves transporting the information. Computer system 1201 can transmit notifications and receive data, including program code, through the network(s), network link 1221 and communication interface 1219. With the system of FIG. 12, the present invention may be implemented on the Internet as a Web Server 1201 performing one or more of the processes according to the present invention for one or more computers 1217 coupled to the Web server 1201 through one or more of the networks 1216 and/or 1215.

Numerous additional advantages, modifications and variations of the present invention are possible in light of the above teachings and will readily occur to those skilled in the art. It is therefore to be understood that within the scope of the appended claims, the present invention may be practiced otherwise than as specifically described herein. Therefore, the present invention is not limited to the specific details, representative devices, and illustrated examples shown and described herein. Accordingly, various modifications may be made without departing from the spirit or scope of the general inventive concept as defined by the appended claims and their equivalents.

What is claimed is:

1. A server computer for electronically introducing merchandise information after closing an electrical auction, said server computer connected through a network to a plurality of terminals, which participate in an auction, said server computer comprising:
a merchandise database storing a plurality of merchandise information;
means for selecting merchandise information from said merchandise database on a basis of provided bid information of a participant; and
means for causing to notify the selected merchandise information as alternative merchandise information to a terminal.

2. The server computer of claim 1, wherein said selecting means comprises:
means for extracting preference information on a basis of stored bid information of a bidder and exhibited merchandise information bid on by the bidder; and
means for selecting merchandise information on a basis of the preference information.

3. The server computer of claim 1, wherein said selecting means selects the merchandise information except for a successful bidder.

4. A server computer for electronically introducing merchandise information after closing an electrical auction, said server computer connected through a network to a plurality of terminals which participate in an auction, said server computer comprising:
an auction execution unit configured to hold an electronic auction, said auction execution unit comprising,
a providing module configured to provide exhibited merchandise information for the auction to the terminals, and
a receiving module configured to receive bid information, which includes bid information indicating a bidder from the terminals and configured to store the bid information;
a merchandise database storing a plurality of merchandise information;
means for selecting merchandise information from the merchandise database on a basis of the stored bid information of a bidder; and
means for causing to notify the selected merchandise information as alternative merchandise information to a terminal.

5. The server computer of claim 4, wherein said selecting means comprises:
means for extracting preference information on a basis of bid information stored for a bidder and the exhibited merchandise information bid on by the bidder, and
means for selecting merchandise information on a basis of the preference information.

6. The server computer of claim 4, wherein said selecting means selects the merchandise information except for a successful bidder.

7. A server computer for electronically introducing merchandise information after closing an electrical auction, said server computer connected through a network to a plurality of terminals which participate in the auction, said server computer comprising:
means for extracting preference information on a basis of bid information stored for a bidder and exhibited merchandise information bid on by the bidder;
means for causing a communication unit to transmit the preference information to an exhibitor.

8. The server computer of claim 7, wherein said extracting means extracts the merchandise information except for a successful bidder.

9. A server computer for electronically introducing merchandise information after closing an electrical auction, said server computer connected through a network to a plurality of terminals which participate in the auction, said server computer comprising:
a storage unit storing bid information;
means for extracting preference information on the basis of bid information stored for a bidder and exhibited merchandise information bid on by the bidder;
means for associating the preference information and bid information and for storing same;
means for receiving alternative merchandise information selected by an exhibitor;
means for causing to notify the alternative merchandise information as alternative merchandise to a terminal on a basis of the associated preference information and bid information.

10. The server computer of claim 9, wherein said extracting means extracts the merchandise information except for a successful bidder.

11. A server computer for electronically introducing merchandise information after closing an electrical auction, said server computer connected through a network to a plurality of terminals which participate in the auction, said server computer comprising:
means for extracting preference information on a basis of bid information stored for a bidder and exhibited merchandise information bid on by the bidder;
means for causing a communication unit to transmit the preference information to an exhibitor;
means for receiving alternative merchandise information selected by the exhibitor;
means for causing to notify the alternative merchandise information as alternative merchandise to a terminal.

12. A server computer for electronically introducing merchandise information after closing an electrical auction, said server computer connected through a network to a plurality of terminals which participate in the auction, said server computer comprising:
means for holding the auction electronically,
said auction holding means, comprising,
means for providing exhibited merchandise information for the auction to the terminals, and
means for receiving bid information, which includes information indicating a bidder, from the terminals and for storing the bid information;
means for extracting preference information on a basis of bid information stored for a bidder and exhibited merchandise information bid on by the bidder;
means for causing a communication unit to transmit the preference information to an exhibitor;
means for receiving alternative merchandise information selected by the exhibitor;
means for causing to notify the alternative merchandise information as alternative merchandise to the terminal.

13. A method of electronically introducing merchandise information to a participant bidding in an electronic auction after closing the electronic auction, in a system including a server computer connected through a network to a plurality of terminals which participate in the auction, said method comprising:
selecting merchandise information from a plurality of merchandise information on a basis of bid information bid by a participant; and
causing to transmit the selected merchandise information as alternative merchandise to a terminal of the participant.

14. The method of claim 13, wherein said selecting step comprises:
extracting preference information on a basis of the bid information and exhibited merchandise information bid on by the participant; and
selecting the merchandise information on a basis of the preference information from the plurality of merchandise information.

15. A method of electronically introducing merchandise information after closing an electronic auction, comprising:
providing exhibited merchandise information for the auction to terminals of participants,
receiving bid information, which includes information indicating each participant from the terminals;
storing the bid information;
selecting merchandise information from a plurality of merchandise information on a basis of the stored bid information; and
causing to transmit the selected merchandise information as alternative merchandise to a terminal of a participant.

16. The method of claim 15, wherein said selecting step comprises:
extracting preference information on a basis of the bid information and exhibited merchandise information bid on by a participant; and
selecting merchandise information on a basis of the preference information from the plurality of merchandise information.

17. A method of electronically introducing merchandise information to a participant bidding in an electronic auction after closing the auction, comprising:
extracting preference information on a basis of bid information and exhibited merchandise information bid on by a participant;
causing to transmit the preference information to a terminal of an exhibitor.

18. A method of electronically introducing merchandise information after closing an electrical auction, comprising:
storing bid information;
extracting preference information on a basis of bid information stored for a bidder and exhibited merchandise information bid on by the bidder;
associating the preference information and bid information and storing same;
receiving alternative merchandise information selected by an exhibitor; and
causing to notify the alternative merchandise information as alternative merchandise to a terminal on a basis of the associated preference information and bid information.

19. A computer program product comprising a computer storage medium having a computer program code mechanism embedded in the computer storage medium configured to perform the steps recited in any one of claims 13-18.

20. An auction system, comprising:
a plurality of terminals offering bids for exhibited merchandise information in an electronic auction; and
a server computer connected the plurality of terminals through a network, configured to hold the auction, said server, including,
a providing module providing exhibited merchandise information to the terminals,
a receiving module receiving bid information, which includes information indicating a bidder from the terminals and storing the bid information;
a merchandise database storing a plurality of merchandise information;
means for selecting merchandise information from the merchandise database on a basis of stored bid information for a bidder; and
means for causing to notify the selected merchandise information as alternative merchandise to a terminal of the bidder.

21. An auction system, comprising:
a plurality of terminals offering a bid on exhibited merchandise information;
a terminal of an exhibitor; and
a server computer, connected the plurality of terminals and the terminal of the exhibitor through a network, and configured to hold an auction, said server, including,
means for providing exhibited merchandise information for the auction to the terminals, and
means for receiving bid information, which includes information indicating a bidder from the terminals and for storing the bid information,
means for extracting preference information on a basis of the stored bid information of the bidder, and the exhibited merchandise information bid on by the bidder;
means for causing a communication unit to transmit a preference information to the exhibitor;
means for receiving an alternative merchandise information selected by exhibitor;
means for causing to notify the alternative merchandise information as an alternative merchandise to the terminal.
